(19) United States
(12) Patent Application Publication
(10) Pub. No.: US 2010/0053992 A1
(43) Pub. Date: Mar. 4, 2010

(54) ILLUMINATION SYSTEM AND DISPLAY DEVICE

(75) Inventors: Marcellinus Petrus Carolus Michael Krijn, Eindhoven (NL); Martin Jacobus Johan Jak, Eindhoven (NL); Ramon Pascal Van Gorkom, Eindhoven (NL); Hugo Johan Cornelissen, Eindhoven (NL); Dirk Kornelis Gerhardus De Boer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,032

(22) PCT Filed: Nov. 20, 2007
(86) PCT No.: PCT/IB07/54706

§ 371 Date: May 15, 2009

(30) Foreign Application Priority Data
Nov. 22, 2006 (EP) 06124549.4

(51) Int. Cl. F21V 7/04

(52) U.S. Cl. 362/606; 362/609; 362/615

(57) ABSTRACT

The invention relates to an illumination system (10) for illuminating a display device, and to the display device. The illumination system comprises a light distribution element (20 for distributing light across the display device. The light distribution element comprises a light output window (40), a rear wall (42) situated opposite the light output window, and edge walls (44, 46) extending between the light output window and the rear wall, at least one of the edge walls comprising a light input window (48) for admitting light into the light distribution element. The light distribution element further comprises specularly reflective light-outcoupling means (50) for specularly reflecting light from the light distribution element towards the display device via the light output window. A first light beam (100) comprises light of a first primary color (R) impinging on the light input window for coupling the light of the first primary color into the light distribution element. At least a second light beam (102, 104) comprises light of a second primary color (G, B) impinging on the light input window for coupling the light of the second primary color into the light distribution element, the second light beam being substantially not parallel to the first light beam. Use of specularly reflective outcoupling means yields a difference between an angle of incidence between the first and the second light beam. This difference is substantially preserved, which results in a color separation of the light emitted by the light distribution element towards the display device.

### FIELD OF THE INVENTION

The invention relates to an illumination system for illuminating a display device.

The invention also relates to a display device.

### BACKGROUND OF THE INVENTION

Illumination systems for illuminating display devices are known per se. They are used, inter alia, in non-emissive displays, such as liquid crystal display devices, also referred to as LCD panels, which are used in, for example, television receivers, (computer) monitors, (cordless) telephones and portable digital assistants. The illumination systems can also be used in, for example, projection systems such as digital projectors, or beamers, for projecting images or displaying television programs, films, video programs or DVDs, or the like. In addition, such illumination systems are used for general lighting purposes, such as for large-area direct-view light-emitting panels applied in, for example, signage, contour lighting, and billboards.

Such an illumination system is disclosed in, for example, U.S. Pat. No. 4,798,448 which discloses an illumination system for a color display device comprising means for splitting the three primary colors of light so that individual cells within the picture elements receive only the desired color of light. The means for splitting the three primary colors as disclosed in the above-cited US patent comprises a diffraction grating. The diffraction grating splits the white light received from lenticular lenses and bends the light so that the three primary colors of light are directed to the individual liquid crystal cells, and each liquid crystal cell receives only the color which is intended to be transmitted through the cell.

The known illumination system has the drawback that it has a relatively low efficiency.

### OBJECT AND SUMMARY OF THE INVENTION

It is an object of the invention to provide an illumination system having an improved efficiency.

According to a first aspect of the invention, this object is achieved with an illumination system comprising:

a light distribution element for distributing light across the display device, the light distribution element comprising a light output window, a rear wall situated opposite the light output window, and edge walls extending between the light output window and the rear wall, at least one of the edge walls comprising a light input window for admitting light into the light distribution element, the light distribution element further comprising specularly reflective light-outcoupling means for specularly reflecting light from the light distribution element towards the display device via the light output window,

means for generating a first light beam comprising light of a first primary color and a second light beam comprising light of a second primary color, the second light beam being substantially not parallel to the first light beam, and

the light input window being arranged to receive the first light beam for coupling the light of the first primary color into the light distribution element, and to receive at least the second light beam for coupling the light of the second primary color into the light distribution element.

The measures according to the invention have the effect that, by virtue of the use of specularly reflective outcoupling means, a difference between an angle of incidence between the first light beam and the second light beam is substantially preserved when, in operation, the light of the first and the second primary color is coupled out from the light distribution element by the specularly reflective outcoupling means. As a result, the light of the first and the second primary color is emitted from the light distribution element at different angles towards the display device, resulting in a color separation of the light emitted by the light distribution element for the light of the first and the second primary color. As compared to the light of the second primary color, the light of the first primary color is emitted into the light distribution element at a different angle with respect to a normal axis of the light input window. The specularly reflective light-outcoupling means are arranged to couple out the light, in operation, from the light distribution element towards the display device. Light reflecting from a specularly reflective surface substantially complies with the law of reflection. According to this law, light impinging on a specularly reflective surface having a specific angle of incidence with respect to a normal axis of the reflective surface is reflected from the specularly reflective surface at an angle of reflectance which is equal to the angle of incidence with respect to the normal axis of the reflective surface. Since light of the first primary color is emitted into the light distribution element at a different angle with respect to the normal axis of the light input window, as compared to light of the second primary color, the reflection of the light of the first primary color from the specularly reflective light-outcoupling means towards the display device is at a different angle with respect to a normal axis of the light output window, as compared to the light of the second primary color. By virtue of the use of a specularly reflective outcoupling means, an angular distribution of the light reflecting from the specularly reflective outcoupling means is substantially preserved, and thus the angular difference between the light of the first and the second primary color is preserved when coupling out the light from the light distribution element. Consequently, the illumination system according to the invention emits light of the first primary color separated from the light of the second primary color, as the light of the second primary color is not emitted parallel to the light of the first primary color. The efficiency of reflection from a specularly reflective surface is relatively high. Due to the combination of specularly reflective light-outcoupling means and non-parallel first and second light beams coupled into the illumination system according to the invention, the emission of separated light of different primary colors is more efficient as compared to the use of the diffraction grating for separating light of different primary colors as shown in the known illumination system.

The inventors have realized that use of the diffraction grating in the known illumination system causes the relatively low efficiency of this system. This low efficiency is caused by scattering losses at the grating and by light being scattered at diffractive orders other than the first order. The illumination system according to the invention receives the first light beam comprising light of the first primary color and the second light beam comprising light of the second primary color. Due to the fact that the second light beam is not parallel to the first light beam, the light of the first and the second primary color is emitted into the light distribution element at different angles. Specularly reflective light-outcoupling elements preserve the angular distribution of the light in the light distribution element when coupling out this light, and thus preserve the angular difference between light of the first primary color and light of the second primary color. Light of the first primary color is emitted from the illumination system according to the invention, separated from light of the second primary color, while the efficiency of the illumination system is improved in comparison with the known illumination system. The means for generating the first and the second light beam may be, for example, a first light source for generating the first light beam and, for example, a second light source for generating the second light beam. Alternatively, the first and second light beams may be produced from a single light source having, for example, dichroic beam splitters for splitting a first and a second beam from the light source. The means for generating the first and the second light beam may also be, for example, a plurality of light-emitting diodes, in which a first group of light-emitting diodes emits light of the first primary color, the light beams emitted by each light-emitting diode from the first group being substantially parallel, and a second group of light-emitting diodes emits light of the second primary color, the light beams emitted by each light-emitting diode from the second group being substantially parallel.

Light of a primary color comprises light having a predefined spectral bandwidth around a specific wavelength. In display devices, typically three primary colors are used, for example, red, green and blue. By using red, green and blue, a full-color image can be generated by the display device, including white. Also other combinations of primary colors, which allow generation of full-color images, for example, red, green, blue, cyan and yellow, may be used in the display device. The number of primary colors used in the display device may vary.

In an embodiment of the illumination system, the light of the first primary color of the first light beam and/or the light of the second primary color of the second light beam comprises polarized light. Specularly reflective outcoupling means as used in the illumination system according to the invention do not only preserve the angular distribution of the light reflected from the specularly reflective outcoupling means, but also substantially preserve the polarization of the light reflected from the specularly reflective outcoupling means. Use of substantially polarized light in the first and/or second light beam has the advantage that the light of the first and the second primary color emitted from the light distribution element is not only angularly separated, but also substantially polarized. Substantially polarized light of a predefined direction of polarization in the illumination system, which is used as a backlight illumination system of a liquid crystal display device, may substantially improve the efficiency of such a device. Liquid crystal display devices typically comprise a pair of polarizers. A first polarizer defines a direction of polarization of the light coupled into the liquid crystal cell. The liquid crystal cell may subsequently influence an orientation of the direction of polarization of the light that has been coupled in, such that the light will be either transmitted or blocked by the second polarizer. When the light emitted by the illumination system according to the invention comprises substantially polarized light, the efficiency of the first polarizer may be improved substantially, or the first polarizer may even be omitted completely. A light source emitting substantially polarized light is, for example, a laser or a laser diode. Alternatively, a light source may be converted into a light source emitting substantially polarized light by, for example, enwrapping a light-emitting diode with a polarization-reflective foil, for example, a foil commercially known as Double Brightness Enhancement foil.

A further embodiment of the illumination system comprises a lens array arranged between the light output window and the display device, the lens array having a plurality of cylindrical lenses for receiving angularly separated light and condensing the angularly separated light at a plurality of focal points of each cylindrical lens. Use of the lens array having the plurality of cylindrical lenses has the advantage that the cylindrical lenses convert the angular separation of light of the first and second primary colors emitted from the light distribution element into a first and a second focal position of the light of the first and second primary colors, respectively. A first set of liquid crystal cells of a display device may be arranged, for example, at the first focal position so as to be illuminated by the first primary color, and a second set of liquid crystal cells of the display device may be arranged, for example, at the second focal position so as to be illuminated by the second primary color.

In an embodiment of the illumination system, the specularly reflective light-outcoupling means are arranged in a plurality of rows of specularly reflective light-outcoupling means, the rows being arranged substantially perpendicularly to a longitudinal axis of the plurality of cylindrical lenses. This embodiment has the advantage that the perpendicular arrangement of the rows of light-outcoupling means and the longitudinal axis of the cylindrical lenses reduces an optical interference between a periodicity in the array of cylindrical lenses and a further periodicity of the rows of light-outcoupling means. The optical interference pattern, also known as Moiré pattern, may result in a non-uniform light intensity of the light emitted from the illumination system. By arranging the plurality of rows of the light-outcoupling means substantially perpendicularly to the longitudinal axis of the plurality of cylindrical lenses, the non-uniformity due to the Moiré pattern will be reduced.

In an embodiment of the illumination system, the specularly reflective light-outcoupling means are distributed at a regular interval associated with an interval of pixels of the display device. This embodiment has the advantage that the association between the specularly reflective light-outcoupling means and the interval of pixels of the display device also reduces any Moiré effects and thus results in an improved uniformity of the light intensity emitted from the illumination system.

In an embodiment of the illumination system, the light distribution element comprises a light guide. Use of a light guide has the advantage that the light of the first and the second primary color may propagate through the light distribution element substantially via total internal reflection, which is a substantially lossless propagation of the light within the light guide.

In an embodiment of the illumination system, the specularly reflective light-outcoupling means comprise a plurality of slits in the light guide, each slit of the plurality of slits having a substantially rectangular shape comprising two substantially parallel specularly reflective surfaces defining an angle with respect to the light output window of the light guide. This embodiment has the advantage that only light which impinges on the specularly reflective surface of the slits at an angle with respect to a normal axis of the specularly reflective surface larger than a predefined angle will be reflected towards the light output window, whereas light which impinges on the specularly reflective surface at an angle with respect to the normal axis of the specularly reflective surface smaller than the predefined angle will be transmitted by the slits and will further propagate through the light guide. The predefined angle is determined by a difference of refractive index of the light guide material and a refractive index inside the slit. When light propagates through the light guide, the light impinges on the specularly reflective surface either after reflection from a first wall of the light guide substantially parallel to the light output window or after reflection from a second wall of the light guide substantially parallel to the rear wall. Generally, the angle with respect to the normal axis of the specularly reflective surface at which the light impinges on this surface is different after reflection from the first wall or after reflection from the second wall of the light guide. If the specularly reflective surface were a mirror surface, the illumination system according to the invention would not only emit light of the first primary color angularly separated from the light of the second primary color, but also light of the first and second primary colors, each in substantially two directions: one direction resulting from light which is reflected from the first wall before impinging on the mirror surface and a second direction resulting from light which is reflected from the second wall before impinging on the mirror surface. As a result, a full separation between light of the first and second primary colors is more difficult. In the illumination system according to the invention, the light-outcoupling means comprise slits having two substantially parallel specularly reflective surfaces. Light impinging on the specularly reflective surface at a relatively small angle of incidence with respect to the normal axis of this surface will be transmitted through the slits, whereas light impinging on the specularly reflective surface at a relatively large angle of incidence with respect to the normal axis of the specularly reflective surface will be reflected from this surface and emitted by the illumination system via the light output window. The first and second light beams must be arranged in such a way that, for example, the light impinging on the specularly reflective surface after reflection from the first wall will be transmitted by this surface, whereas light impinging on the specularly reflective surface after reflection from the second wall will be reflected. This allows a clear angular separation of the light of the first and the second primary color emitted by the light distribution element.

In an embodiment of the illumination system, the specularly reflective light-outcoupling means comprise a plurality of triangularly shaped specularly reflective outcoupling elements. The triangular specularly reflective outcoupling element may be arranged, for example, at the rear wall of the light distribution element. Triangularly shaped specularly reflective outcoupling elements have the advantage that they are relatively easy to produce.

In an embodiment of the illumination system, the triangularly shaped specularly reflective outcoupling elements are arranged substantially symmetrically with respect to a normal axis of the light output window. This embodiment has the advantage that light progressing through the light distribution element in a direction substantially parallel to the light output window and impinging on the triangularly shaped reflective outcoupling elements from opposite sides will be directed towards the light output window while preserving the angular distribution of the light. In the light distribution element, light may travel in opposite directions, for example, when reflected from an edge of the light distribution element. When triangular specularly reflective outcoupling elements are applied, the reflected light will also be coupled out towards the light output window while substantially preserving the angular difference between light of the first and the second primary color.

In an embodiment of the illumination system, the light distribution element has a wedge-like shape. This embodiment has the advantage that the wedge-like shape allows a substantially uniform distribution of the light across the light output window of the light distribution element.

In an embodiment of the illumination system, the wedge-like shape has a stepwise reduction of a thickness of the light distribution element in a direction away from the light input window, an interface between two consecutive steps comprising a specularly reflective light-outcoupling element from the plurality of specularly reflective outcoupling elements, the thickness of the light distribution element being a dimension of the light distribution element in a direction substantially perpendicular to the light output window. This embodiment has the advantage that the stepwise reduced light guide allows a uniform distribution of the light while integrating the specularly reflective outcoupling element.

In an embodiment of the illumination system, the specularly reflective light-outcoupling means have a curved specularly reflective surface. The curved specularly reflective surface may be, for example, parabola-shaped. This embodiment has the advantage that this curved specularly reflective surface can be used to redirect the reflected light and as such influence a uniformity of the light emitted from the light output window of the light distribution element. Each reflective light-outcoupling means may have a curved (e.g. parabola-shaped) specularly reflective surface, or, alternatively, the specularly reflective light-outcoupling means may jointly form a curved (e.g. parabola-shaped) specularly reflective surface.

In an embodiment of the illumination system, the specularly reflective light-outcoupling means are constituted by semitransparent mirrors defining an angle with respect to the light output window. This embodiment has the advantage that the transparency of the semitransparent reflective surface may be used to influence a distribution of the light within the light distribution element.

In an embodiment of the illumination system, the specularly reflective light-outcoupling means are distributed in the light distribution element for generating a substantially uniform distribution of the light of the first and the second primary color emitted from the light output window.

The invention also relates to a display device comprising the illumination system according to the invention.

### BRIEF DESCRIPTION OF THE DRAWINGS

These and other aspects of the invention are apparent from and will be elucidated with reference to the embodiments described hereinafter.

In the drawings:

FIG. 1A is a schematic cross-sectional view of an illumination system according to the invention,

FIG. 1B is a schematic top view of the illumination system according to the invention,

FIG. 2A shows a detailed part of the schematic cross-sectional view in FIG. 1A, elucidating the progression of light through the illumination system and the outcoupling of light from the illumination system,

FIG. 2B shows an embodiment of the specularly reflective light-outcoupling means in detail,

FIG. 3 shows an embodiment of the display device according to the invention,

FIG. 4 shows an embodiment of the display device according to the invention, in which the illumination system comprises triangularly shaped specularly reflective outcoupling elements arranged substantially symmetrically with respect to a normal axis of the light output window,

FIG. 5 shows a further embodiment of the display device comprising the illumination system according to the invention, in which rows of specularly reflective light-outcoupling means are arranged substantially perpendicularly to a longitudinal axis of the cylindrical lenses,

FIG. 6 shows an embodiment of the display device according to the invention, in which the illumination system comprises a wedge-shaped light guide, in which a thickness of the wedge-shaped light guide is stepwise reduced in a direction away from the light input window,

FIG. 7 shows an embodiment of the display device according to the invention, in which the specularly reflective light-outcoupling means have a parabola-shaped specularly reflective surface,

FIG. 8 shows an embodiment of the display device according to the invention, in which the parabola-shaped specularly reflective surface is formed via a Fresnel-type reflective surface,

FIG. 9 shows an embodiment of the display device according to the invention, in which the specularly reflective light-outcoupling means are constituted by semitransparent mirrors.

The Figures are purely diagrammatic and not drawn to scale. Particularly for clarity, some dimensions are exaggerated strongly. Similar components in the Figures are denoted by the same reference numerals as much as possible.

### DESCRIPTION OF EMBODIMENTS

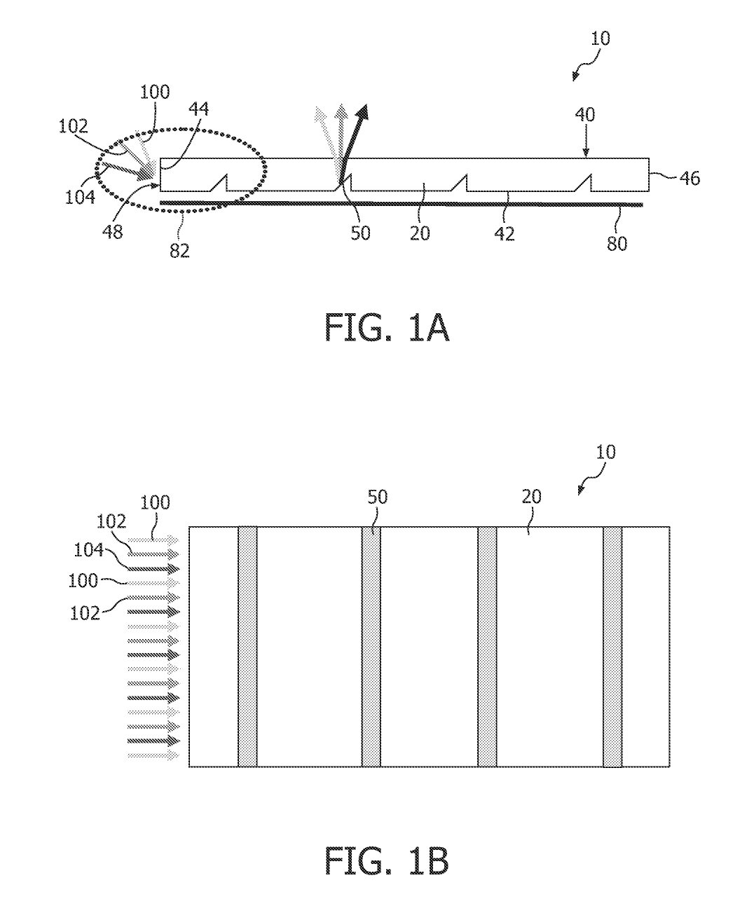

FIG. 1A is a schematic cross-sectional view of an illumination system 10 according to the invention. The illumination system 10 comprises a light distribution element 20 constituted by a light guide 20, also known as optical waveguide, and a mirror 80. The light guide 20 comprises a light output window 40, also known as light exit window, a rear wall 42 and edge walls 44, 46. One of the edge walls 44, 46 comprises a light input window 48, also known as light entrance window, for admitting light into the light guide 20. The light guide 20 further comprises specularly reflective light-outcoupling means 50 for specularly reflecting light from the light guide 20 towards the light output window 40. The specularly reflective light-outcoupling means 50 are constituted by triangular slits forming the triangularly shaped specularly reflective outcoupling elements, for example, arranged in rows (see FIG. 1B). In the embodiment shown in FIG. 1A, a light source (not shown) generates a first light beam 100, a second light beam 102 and a third light beam 104 which impinge on the light input window 48 for coupling light into the light guide 20. The light source may be, for example, a first light source (for example, a laser, a LED or a gas discharge lamp) for generating the first light beam, a second light source (for example, a laser, a LED or a gas discharge lamp) for generating the second light beam, and a third light source (for example, a laser, a LED or a gas discharge lamp) for generating the third light beam. Alternatively, the first, second and third light beams may be produced from a single light source (for example, a laser, a LED or a gas discharge lamp) having, for example, dichroic beam splitters for splitting a first, a second and a third beam from the light source. The light source may also be, for example, a plurality of light-emitting diodes, a first group of which emits light of the first primary color, in which the light beams emitted by each light-emitting diode from the first group are substantially parallel, a second group emits light of the second primary color, in which the light beams emitted by each light-emitting diode from the second group are substantially parallel, and a third group emits light of the third primary color, in which the light beams emitted by each light-emitting diode from the third group are substantially parallel. The first light beam 100 comprises light of a first primary color R, for example, the primary color red. The second light beam 102 comprises light of a second primary color G, for example, the primary color green. The third light beam 104 comprises light of a third primary color B, for example, the primary color blue. Each angle of incidence at which the first, the second and the third light beam 100, 102, 104 impinge on the light input window 48 is different. After the light of the first, the second and the third light beam 100, 102, 104 has been coupled into the light guide 20, the light of the first primary color R, the second primary color G and the third primary color B are substantially confined in the light guide 20 via total internal reflection. Due to the difference in the angle of incidence between the light beams 100, 102, 104, the light of the first primary color R will propagate through the light guide 20 while reflecting from the light output window 40 and from the rear wall 42 at a different internal reflection angle as compared to the light of the second primary color G and the light of the third primary color B. When the light of the first, the second and the third primary color R, G, B impinges on the specularly reflective light-outcoupling means 50, the direction of the light is changed towards the light output window 40 and emitted from the light guide 20. The angle of incidence at which light of the first primary color R impinges on the specularly reflective light-outcoupling means 50 is different from the angle of incidence of light of the second primary color G and light of the third primary color B, resulting in a preservation of the angular separation of the light of the first, the second and the third primary color R, G, B when the light is emitted from the light guide 20 via the light output window 40. Using specularly reflective light-outcoupling means 50 and having a light distribution element 20 in which the light is confined via specular reflection, the angular separation of the first, the second and the third light beam 100, 102, 104 is preserved by the illumination system 10 according to the invention. The light emitted from the illumination system 10 thus comprises angularly separated light of the first primary color R, light of the second primary color G and light of the third primary color B.

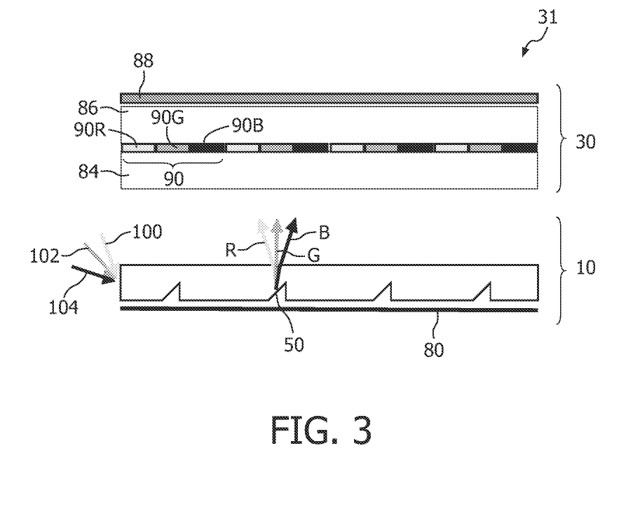

FIG. 1B is a schematic top view of the illumination system 10 according to the invention. The first, the second, and the third light beam 100, 102, 104 generated by a light source (not shown) impinge on the light input window 48 of the light guide 20, in which the angle of incidence of the first, the second and the third light beam 100, 102, 104 on the light input window 48 is different. In the embodiment shown in FIG. 1B, the light of the first, the second and the third light beam 100, 102, 104 seems to be arranged substantially parallel when viewed in a top view. However, the angle of incidence of the first, the second and the third light beam 100, 102, 104 differs with respect to a plane perpendicular to the light output window 40 (as shown in FIG. 1A). Alternatively, the first, the second and the third light beam 100, 102, 104 may impinge on, for example, the light input window 48 of the light guide 20 at different angles of incidence with respect to a plane parallel to the light output window 40 (as shown in FIG. 3) or at different angles of incidence both with respect to the plane parallel to the light output window 40 and the plane perpendicular to the light output window 40 (not shown). The specularly reflective light-outcoupling means 50 may comprise, for example, a triangularly shaped continuous line as shown in FIG. 1A. Alternatively, the line indicating the specularly reflective light-outcoupling means 50 in FIG. 1B may be a row comprising a plurality of separate specularly reflective light-outcoupling means 50.

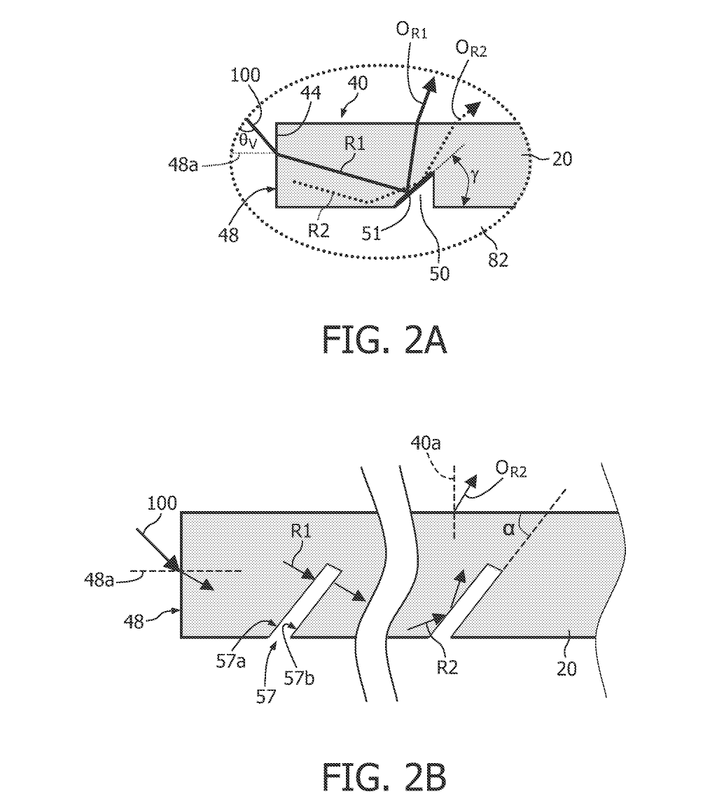

FIG. 2A shows a detailed part 82 of the schematic cross-sectional view in FIG. 1A, elucidating the progression of light through the light guide 20 and the outcoupling of light from the light guide 20. The detailed part 82 shows the progression and outcoupling only for the first light beam 100 comprising light of the first primary color R. However, the same principle holds for the second light beam 102 and the third light beam 104. The first light beam 100 impinges on the light input window 48 at an angle of incidence θv with respect to a normal axis 48a of the light input window 48. In FIG. 2A, the refractive index of the light guide 20 is assumed to be higher than the refractive index of the surroundings of the light guide 20. The light guide 20 may be made of, for example, glass (refractive index: n_{glass}=1.51), or, for example, a much lighter substantially transparent plastic material, for example, polymethyl metacrylate (refractive index: n_{PMMA}=1.49) or, for example, polycarbonate (refractive index: n_{PC}=1.59). The surroundings of the light guide may be, for example, air (refractive index: nₐᵢᵣ=1.00). Light propagating from the surroundings (air in the example of FIG. 2A) into the light guide 20 having a higher refractive index is refracted towards the normal axis 48a, as is shown in FIG. 2A. Once the light of the first primary color R from the first light beam 100 is inside the light guide 20, the light progresses through the light guide 20 via total internal reflection where the angle of reflectance, when reflecting from the light output window 40 and from the rear wall 42, is substantially equal to the angle of incidence on the light output window 40 and on the rear wall 42. The detailed part 82 further shows a specularly reflective light-outcoupling means 50 having a reflective coating 51. The light propagating through the light guide 20 may impinge on the specularly reflective light-outcoupling means 50 either directly (or after reflection from the light output window 40), which is indicated in FIG. 2A by a solid line R1 inside the light guide 20, or the light propagating through the light guide 20 may impinge on the specularly reflective light-outcoupling means 50 after reflection from the rear wall 42, which is indicated by a dotted line R2 in FIG. 2A. Generally, the angle of incidence on the specularly reflective light-outcoupling means 50 for the solid line R1 and the dotted line R2 is different, resulting in a first output light beam O_{R1} of light of the first primary color R and in a second output light beam O_{R2} being angularly separated. The occurrence of two output light beams O_{R1}, O_{R2} is generally not preferred. This may be solved by means of the specularly reflective light-outcoupling means 50 which does not comprise the reflective coating 51, and light impinging on the specularly reflective light-outcoupling means 50 at a relatively small angle of incidence with respect to a normal axis of these means (not shown) will thus be transmitted through the specularly reflective light-outcoupling means, whereas light impinging on the specularly reflective light-outcoupling means 50 at a relatively large angle of incidence will be reflected towards the light output window 40 to be emitted from the light guide 20. Alternatively, the specularly reflective light-outcoupling means 50 may be constituted by rectangular slits as shown in FIG. 2B.

FIG. 2B shows an embodiment of the specularly reflective light-outcoupling means 50 in detail. The specularly reflective light-outcoupling means 50 are constituted by rectangular slits 57 in the light guide 20. The rectangular slits 57 have two substantially parallel specularly reflective surfaces 57a, 57b defining an angle α with respect to the light output window 40 of the light guide 20. The slits 57 are, for example, filled with air, or, alternatively, with a different substance having a different refractive index than the light guide 20. Due to the difference in refractive index between the light guide 20 and the inside of the slits 57, only light impinging on the specularly reflective surface 57a at an angle of incidence with respect to a normal axis (not shown) of the specularly reflective surface 57a larger than a predefined angle will be reflected, whereas light impinging on the specularly reflective surface 57a at an angle of incidence smaller than the predefined angle will be transmitted and continue to progress through the light guide 20 via total internal reflection. This embodiment has the advantage that it can prevent the occurrence of two angularly separated light beams having substantially the same primary color (see FIG. 2A, the output light beams O_{R1}, O_{R2}). A left part of FIG. 2B shows an arrangement in which light of the first primary color R1 impinges on the specularly reflective surface 57a at a relatively small angle of incidence and is transmitted through the slit 57. A right part of FIG. 2B shows an arrangement in which the light of the first primary color R2 propagating through the light guide 20 is reflected from the rear wall 42 and subsequently impinges on the specularly reflective surface 57a at a relatively large angle of incidence, which light is subsequently reflected towards the light output window 40 for emission from the light guide 20. Consequently, the light of the first primary color R is emitted from the light guide 20 in a single output light beam O_{R2} or in a plurality of output light beams O_{R2} arranged substantially parallel, thus avoiding angular separation of the light of the first primary color R. In FIG. 2B, the effect of using the slits 57 as specularly reflective outcoupling means 50 is elucidated only for the first light beam 100 comprising light of the first primary color R. However, the same principle holds for the second light beam 102 and the third light beam 104.

FIG. 3 shows an embodiment of the display device 31 according to the invention. The display device 31 comprises the illumination system 10 as shown in FIG. 1A, and an image-creation layer 30 comprising pixels 90 having a plurality of sub-pixels 90R, 90G, 90B, for example, one sub-pixel for every primary color R, G, B. The pixels 90 are arranged between substantially transparent substrates 86, 84, for example, comprising electric contacts (not shown) for driving the sub-pixels 90R, 90G, 90B. Generally, a transmission of the light of the sub-pixels 90R, 90G, 90B can be controlled, thus controlling a contribution of each primary color R, G, B to the color and intensity of the pixel 90. An image may be created by controlling an intensity and color of the light emitted from each pixel 90 of the display device 31. In the embodiment of the display device 31 shown in FIG. 3, one specularly reflective outcoupling means 50 is associated with one pixel 90. The image-creation layer 10 shown in FIG. 3 only shows a layer of pixels 90 sandwiched between two substrates and a diffuser layer 88. Each pixel 90 comprises three sub-pixels 90R, 90G, 90B in which, for example, each sub-pixel 90R, 90G, 90B is constituted by a cell comprising liquid crystals, further also referred to as LC-cells, which are able to influence a direction of polarization of the transmitted light. Generally, the image-creation layer 10 also comprises a polarizing layer (not shown), a set of electric contact layers (not shown) for driving the LC-cells, and an analyzing layer (not shown) for defining a direction of polarization of the emitted light. Although these elements have been omitted for reasons of simplicity, it is well-known in the art in which way these elements should be applied to obtain an image on the display device 31.

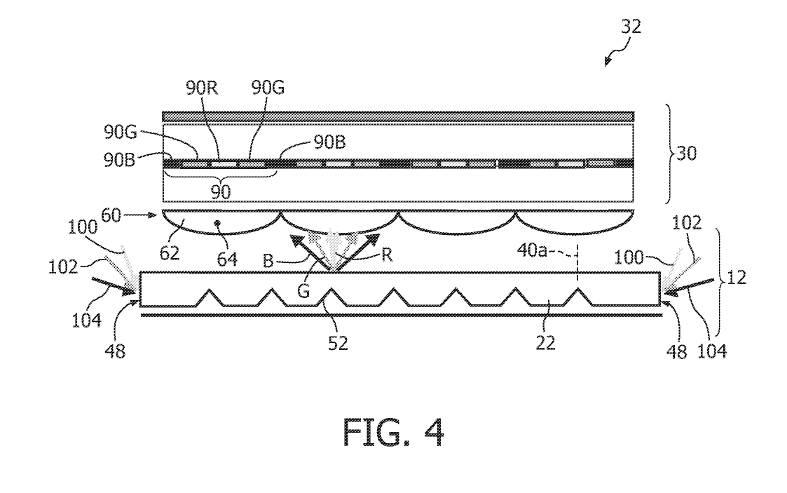

FIG. 4 shows an embodiment of the display device 32 according to the invention. The display device 32 shown in FIG. 4 comprises an array 60 of cylindrical lenses 62 for receiving the separated light R, G, B and condensing the separate light R, G, B at a focal point of a cylindrical lens 62, for example, at the sub-pixels 90R, 90G, 90B of the pixel 90. Use of cylindrical lenses 62 has the advantage that the distribution of the specularly reflective light-outcoupling means 50 does not need to be associated with the interval of the pixels 90 in the image-creation layer 30. As all light of a specific primary color R, G, B is emitted substantially parallel from the light output window 40, the cylindrical lenses 62 will condense all light impinging on a cylindrical lens 62 at a certain angle with respect to a longitudinal axis 64 of the cylindrical lens 62 into one focal point. In the embodiment of the display device 32 shown in FIG. 4, the illumination system 12 comprises triangularly shaped specularly reflective outcoupling elements 52 which are arranged substantially symmetrically with respect to a normal axis 40a of the light output window 40. Due to the symmetric arrangement of the triangular specularly reflective outcoupling elements 52, light progressing through the light guide 22 in a direction substantially parallel to the light output window 40 and impinging on the triangular reflective outcoupling elements 52 from opposite sides will be directed towards the light output window 40 while preserving the angular distribution of the light. In the light guide 22, light may travel in opposite directions, for example, when reflected from an edge wall 44, 46 of the light guide 22 (not shown). In the embodiment shown in FIG. 4, the light guide 22 comprises two light input windows 48 at opposite sides of the light guide 22 for coupling light into the light guide 22. Light of the first primary color R is coupled into both light input windows 48 at substantially the same angles of incidence. Furthermore, the triangular specularly reflective outcoupling elements 52 are arranged to couple out the light of the first primary color substantially parallel to the normal axis 40a of the light output window 40, resulting in the light of the first primary color R, which propagates through the light guide 22 in opposite directions, being emitted substantially parallel to the normal axis 40a. When also the light of the second primary color G is coupled into both light input windows 48 at substantially the same angles of incidence, and the light of the third primary color B is coupled into both light input windows 48 at substantially the same angles of incidence, the light emitted from the triangular specularly reflective outcoupling elements 52 is arranged substantially symmetrically with respect to the normal axis 40a. This has the advantage that an angular distribution of the light emitted from the light output window 40 is arranged substantially symmetrically with respect to the normal axis 40a. Alternatively, the triangular specularly reflective outcoupling element 52 may be replaced, for example, by first and second rectangular slits 57 (see FIG. 2B), in which the second rectangular slit (not shown) is a mirror image of the first rectangular slit 57 formed by reflection in the normal axis 40a of the light output window 40.

The pixels 90 in the image-creation layer 30 comprise a plurality of sub-pixels 90R, 90G, 90B. The arrangement of sub-pixels 90R, 90G, 90B preferably corresponds to the angular distribution of the light emitted from the illumination system 12, for example, comprising a symmetric arrangement of sub-pixels 90R, 90G, 90B with respect to the normal axis N. In the embodiment shown in FIG. 4, each pixel 90 comprises one sub-pixel 90R for the primary color red R, two sub-pixels 90G for the primary color green G and two sub-pixels 90B for the primary color blue B. In the pixel arrangement shown in FIG. 4, each pixel 90 shares the sub-pixels 90B for the primary color blue B with neighboring pixels 90 on either side of the pixel 90, effectively resulting in one sub-pixel 90B for the primary color blue B per pixel 90. This embodiment has the advantage that the pixels 90 may be smaller, thus allowing a higher resolution.

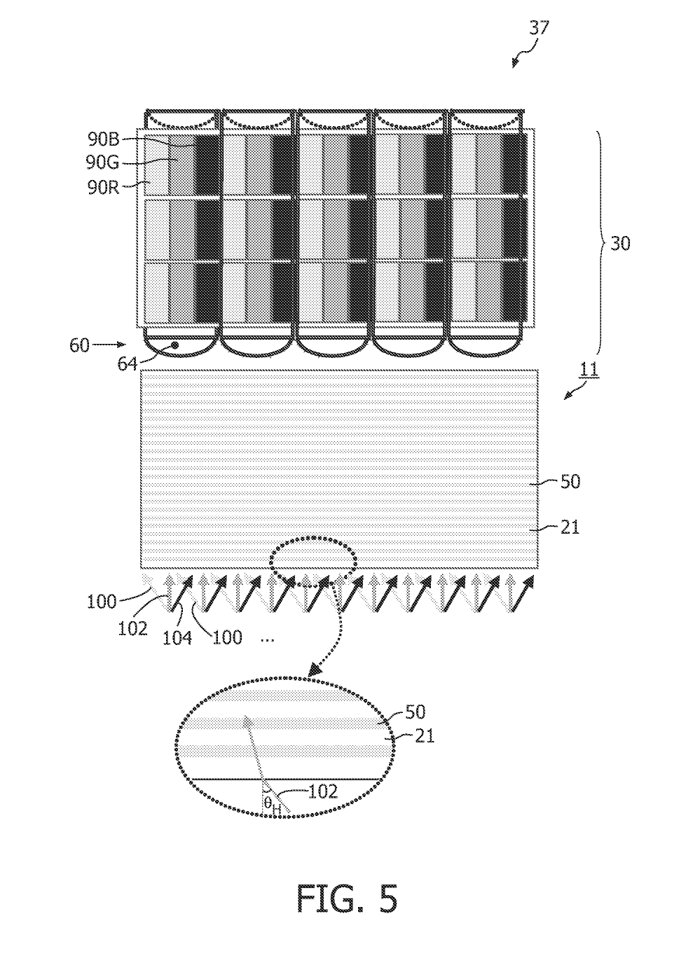

FIG. 5 shows a further embodiment of a display device 37 comprising the illumination system 11 according to the invention, in which rows of specularly reflective light-outcoupling means 50 are arranged substantially perpendicularly to the longitudinal axis 64 of the cylindrical lenses 62. The display device 37 comprises the image-creation layer 30 and the illumination system 11 comprising the light distribution element 21, for example, a light guide 21. For clarity reasons, the image-creation layer 30 together with the array 60 of cylindrical lenses 62 has been shifted away from the illumination system 11. Sub-pixels 90R, 90G, 90B, which must be illuminated with light of the same primary color, are arranged in rows parallel to the longitudinal axis 64 of the cylindrical lenses 62. The first, the second and the third light beam 100, 102, 104 impinge on the light input window 48 of the illumination system 11 at different angles with respect to the normal axis 48a (see FIG. 2A) of the light input window 48 in a plane parallel to the light output window 40. Alternatively, the first, the second and the third light beam 100, 102, 104 may additionally also impinge at different angles θ_{H} with respect to the normal axis 48a in a plane perpendicular to the light output window 40. The specularly reflective light-outcoupling means 50 are, for example, identical as is shown in FIG. 2A or 2B. Also in the configuration shown in FIG. 5, in which the rows of specularly reflective light-outcoupling means 50 are arranged perpendicularly to the longitudinal axis 64 of the cylindrical lenses, the angular difference between the first, the second and the third light beam 100, 102, 104 is substantially preserved by the illumination system 11, resulting in angular separation of the light emitted from the light output window 48 of the light guide 20. This embodiment has the advantage that the perpendicular arrangement of the rows of specularly reflective light-outcoupling means 50 and the longitudinal axis 64 of the cylindrical lenses 62 reduces an optical interference between a periodicity in the array of cylindrical lenses 60 and a further periodicity of the rows of specularly reflective light-outcoupling means 50. The optical interference pattern, also known as Moiré pattern, may result in a non-uniform light intensity of the light emitted from the illumination system 11. The substantially perpendicular arrangement of the plurality of rows of the specularly reflective light-outcoupling means 50 with respect to the longitudinal axis 64 of the plurality of cylindrical lenses 62 reduces the non-uniformity due to the Moiré pattern.

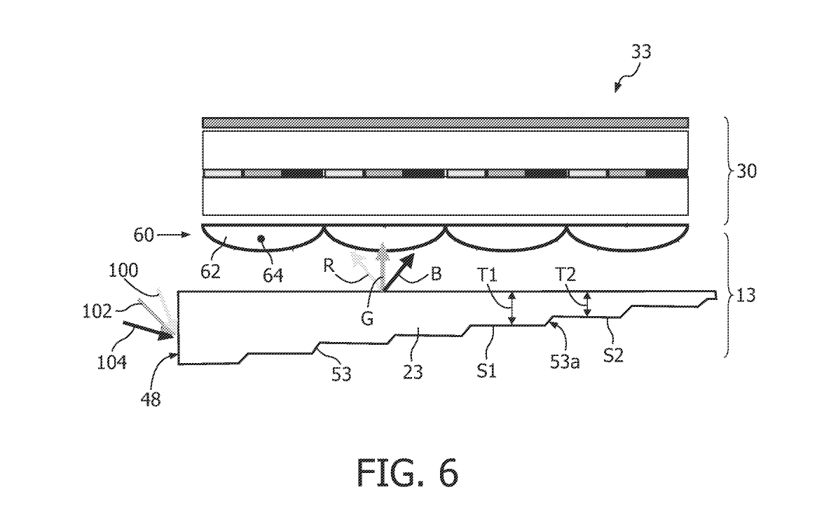

FIG. 6 shows an embodiment of the display device 33 according to the invention, in which the illumination system 13 comprises a wedge-shaped light guide 23 whose thickness T1, T2 is stepwise reduced in a direction away from the light input window 48. An interface 53a between two consecutive steps S1, S2 comprises the specularly reflective outcoupling means 53 from the plurality of specularly reflective outcoupling means 53. The thickness T1, T2 of the light guide 23 is defined in a direction substantially perpendicular to the light output window 40. This embodiment has the advantage that the stepwise reduced light guide 23 allows a uniform distribution of the light while integrating the specularly reflective outcoupling element 53.

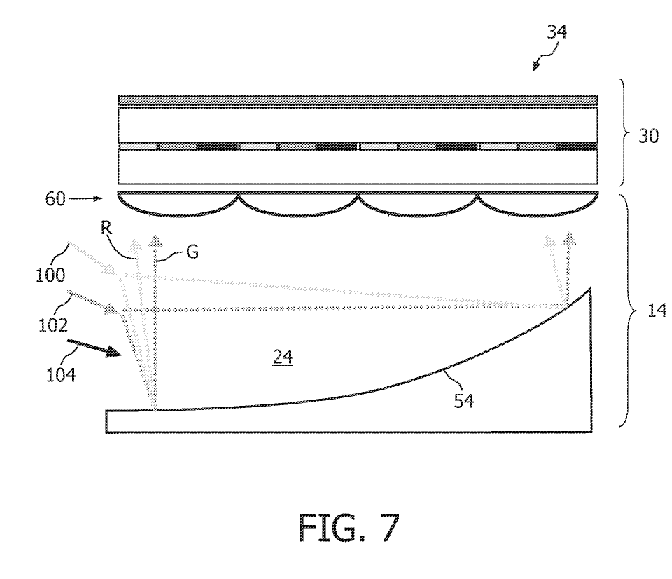

FIG. 7 shows an embodiment of the display device 34 according to the invention, comprising the image-creation layer 30 and the illumination system 14. The illumination system 14 comprises the specularly reflective light-outcoupling means 50. In the embodiment shown in FIG. 7, the specularly reflective light-outcoupling means 50 are constituted by a parabola-shaped specularly reflective surface 54. A reflecting surface, for example, a parabola-shaped mirror 54 is used instead of a light guide in the light distribution element 24. The embodiment shown in FIG. 7 has the advantage that the parabola-shaped specularly reflective surface 54 may be used, for example, to redirect the reflected light and as such, for example, influence a uniformity of the light of the first, the second and the third primary color R, G, B emitted from the light output window 40 of the light distribution element 24.

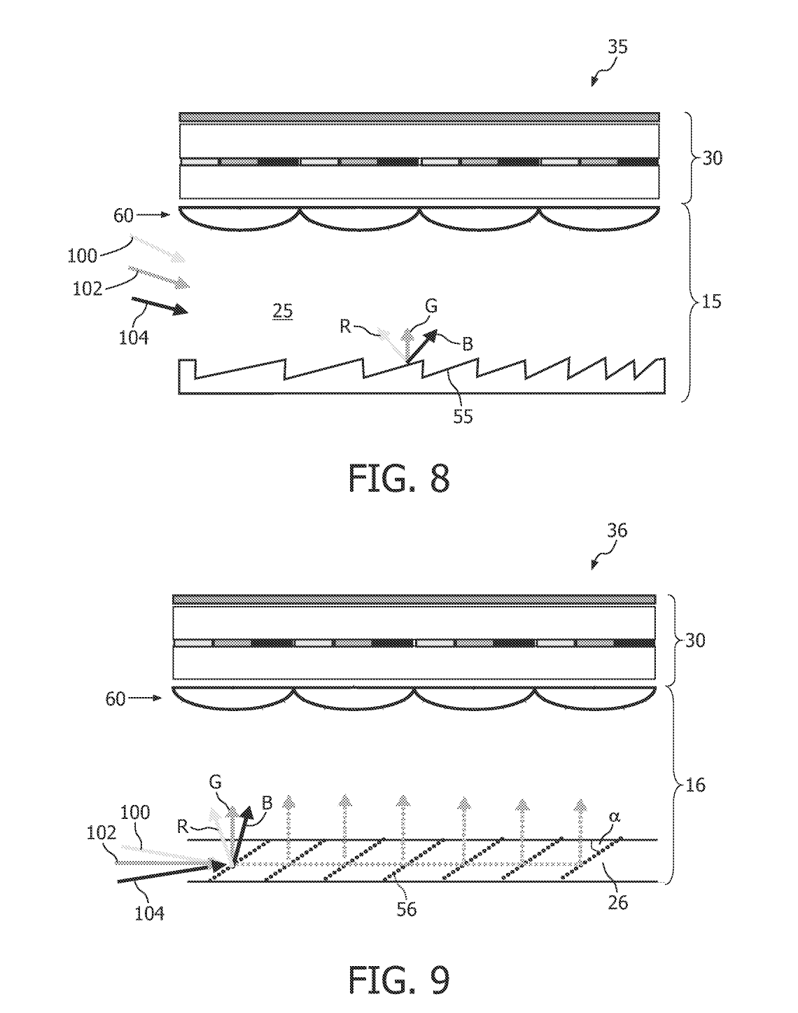

FIG. 8 shows an embodiment of the display device 35 according to the invention, comprising the image-creation layer 30 and the illumination system 15. The illumination system 15 has a plurality of specularly reflective surfaces 55, for example, forming a Fresnel-type reflective surface. The embodiment shown in FIG. 8 has the advantage that a thickness of the illumination system 15 can be reduced with respect to the embodiment shown in FIG. 7.

FIG. 9 shows an embodiment of the display device 36 according to the invention, in which the specularly reflective light-outcoupling means 50 are constituted by semitransparent mirrors 56. The display device 36 shown in FIG. 9 again comprises the image-creation layer 30 and the illumination system 16. The illumination system 16 comprises a light distribution element 26 with semitransparent mirrors 56 defining an angle α with respect to the light output window 40 of the light distribution element 26. The light distribution element 26 may consist of, for example, a box having specularly reflective walls and comprising the semitransparent mirrors 56. The box may comprise, for example, an angularly reflective filter (not shown) at the light output window 40 so as to confine light impinging on the light output window 40 at a relatively large angle with respect to the normal axis 40a of the light guide. Alternatively, the light distribution element 26 may be constituted by, for example, rows of adjacent light guides. The adjacent light guides have, for example, edge walls forming the angle α with respect to the light output window 40. The semitransparent mirrors 56 are formed, for example, by small air gaps (not shown) between two adjacent light guides. This embodiment has the advantage that the transparency of the semitransparent reflective surfaces 56 may be used to influence a distribution of the light within the light distribution element 26.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. An illumination system for illuminating a display device, the illumination system comprising:
a light distribution element for distributing light across the display device, the light distribution element comprising a light output window, a rear wall situated opposite the light output window, and edge walls extending between the light output window and the rear wall, at least one of the edge walls comprising a light input window for admitting light into the light distribution element, the light distribution element further comprising specularly reflective light-outcoupling means for specularly reflecting light from the light distribution element towards the display device via the light output window,
means for generating a first light beam comprising light of a first primary color (R) and a second light beam comprising light of a second primary color (G, B), the second light beam being substantially not parallel to the first light beam, and
the light input window being arranged to receive the first light beam for coupling the light of the first primary color (R) into the light distribution element, and to receive at least the second light beam for coupling the light of the second primary color (G, B) into the light distribution element, wherein the light of the first primary color (R) is emitted, in operation, into the light distribution element at a different angle (θv) with respect to a normal axis of the light input window compared to the light of the second primary color (G, B).

2. An illumination system as claimed in claim 1, wherein the light of the first primary color (R) of the first light beam and/or the light of the second primary color (G, B) of the second light beam comprises polarized light.

3. An illumination system as claimed in claim 1, wherein the illumination system further comprises a lens array arranged between the light output window (40) and the display device, the lens array having a plurality of cylindrical lenses for receiving angularly separated light and condensing the angularly separated light at a plurality of focal points of each cylindrical lens.

4. An illumination system as claimed in claim 3, wherein the specularly reflective light-outcoupling means are arranged in a plurality of rows of specularly reflective light-outcoupling means, the rows being arranged substantially perpendicularly to a longitudinal axis of the plurality of cylindrical lenses.

5. An illumination system as claimed in claim 1, wherein the specularly reflective light-outcoupling means are distributed at a regular interval associated with an interval of pixels of the display device.

6. An illumination system as claimed in claim 1, wherein the light distribution element comprises a light guide.

7. An illumination system as claimed in claim 6, wherein the specularly reflective light-outcoupling means comprise a plurality of slits in the light guide, each slit of the plurality of slits having a substantially rectangular shape comprising two substantially parallel specularly reflective surfaces defining an angle (α) with respect to the light output window of the light guide.

8. An illumination system as claimed in claim 1, wherein the specularly reflective light-outcoupling means comprise a plurality of triangularly shaped specularly reflective outcoupling elements.

9. An illumination system as claimed in claim 8, wherein the triangularly shaped specularly reflective outcoupling elements (50, 52) are arranged substantially symmetrically with respect to a normal axis of the light output window

10. An illumination system as claimed in claim 1, wherein the light distribution element has a wedge-like shape.

11. An illumination system as claimed in claim 10, wherein the wedge-like shape (23) has a stepwise reduction of a thickness (T1, T2) of the light distribution element in a direction away from the light input window, an interface (53a) between two consecutive steps (S1, S2) comprising a specularly reflective light-outcoupling element (53) from the plurality of specularly reflective outcoupling elements, the thickness (T1, T2) of the light distribution element being a dimension of the light distribution element in a direction substantially perpendicular to the light output window (40).

12. An illumination system as claimed in claim 1, wherein the specularly reflective light-outcoupling means have a curved specularly reflective surface.

13. An illumination system as claimed in claim 1, wherein the specularly reflective light-outcoupling means are constituted by semitransparent mirrors defining an angle (α) with respect to the light output window.

14. An illumination system as claimed in claim 1, wherein the specularly reflective light-outcoupling means are distributed in the light distribution element for generating a substantially uniform distribution of the light of the first and the second primary color (R, G, B) emitted from the light output window.

15. (canceled)
